(19) United States
(12) Patent Application Publication
(10) Pub. No.: US 2009/0122545 A1
(43) Pub. Date: May 14, 2009

(54) LIGHT SOURCE DEVICE AND IMAGE DISPLAY APPARATUS

(75) Inventor: Daisuke UCHIKAWA, Shiojiri-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/266,135

(22) Filed: Nov. 6, 2008

(30) Foreign Application Priority Data
Nov. 12, 2007 (JP) 2007-292875
Feb. 26, 2008 (JP) 2008-043934

(51) Int. Cl. F21V 33/00; F21V 7/04

(52) U.S. Cl. 362/253; 362/296.1

(57) ABSTRACT

A light source device whose emitted light is collimated using a collimating system includes a light source unit, and an opening member disposed on the optical path of light emitted from the light source unit to allow a part of the light emitted from the light source unit to pass through the opening member through an opening and block light other than the light entering the opening.

### BACKGROUND

1. Technical Field

The present invention relates to a light source device and an image display apparatus, and more particularly to a technology of a light source device and an image display apparatus for displaying images by laser beam scanning.

2. Related Art

Currently, a technology of an image display apparatus which uses a laser beam source as a light source has been proposed. The laser beam source was developed as a light source for projector and display as image display apparatus with increase in output and color multiplication of the image display apparatus. Compared with UHP lamp used as a light source of a projector in related art, the laser beam source provides advantages such as high color reproducibility, instant lighting, and long life. Moreover, the laser beam source achieves increase in light emission efficiency than that of the related-art light source and reduction of energy loss, and requires a small number of optical elements. Thus, the laser beam source contributes to power saving of the device. There is a type of image display apparatus which uses laser beam modulated according to image signals for laser beam scan. The image display apparatus which scans laser beam typically includes a light source system, a combining system for combining a plurality of color lights into a single light, and a scanning system for scanning combined light, These systems are constituted by a single device or element, and thus size and cost of the image display apparatus for laser beam scanning is expected to be reduced. A method of collimating light emitted from the light source using a collimating system has been proposed as a technology of the laser beam scanning image display apparatus (for example, see JP-A-2-118511 and JP-A-2007-79577).

Semiconductor laser is widely used as the laser beam source. There is such a laser medium which can directly oscillate red laser light and blue laser light.

The semiconductor laser has been chiefly developed in the field of optical disk, and there is thus the highest possibility that the semiconductor laser is applied to low-output devices. A typical semiconductor laser has a so-called buried ridge (BR) structure. According to the BR structure, carrier and light can be effectively closed in the thickness direction of the layer constituting the semiconductor laser. However, the BR structure cannot sufficiently close carrier and light in an active layer in the direction parallel with the layer, and light is possibly leaked out in the direction parallel with the active layer. As a result, a long light emission area is formed at a position adjacent to the original light emission point in the direction parallel with the active layer in some cases. It is known that a belt-shaped beam receiving area is produced as well as a desired beam spot when light emitted from the semiconductor laser in this condition enters the collimating system. In this case, the belt-shaped beam receiving area is scanned as well as the desired beam spot, or generated stray light reaches the screen. As a result, contrast and quality of images are lowered. Particularly when a scanning system having a large reflection surface such as polygon mirror and galvano mirror is used, the belt-shaped beam receiving area is scanned as it is, which results in considerable adverse effect. According to the related art, therefore, it is difficult to produce high contrast and high quality images in some cases at the time of scan of light emitted from the light source device.

### SUMMARY

It is an advantage of some aspects of the invention to provide a light source device and an image display apparatus capable of producing high contrast and high quality images at the time of scan of light emitted from the light source device.

A light source device according to a first aspect of the invention, whose emitted light is collimated using a collimating system, includes: a light source unit; and an opening member disposed on the optical path of light emitted from the light source unit to allow a part of the light emitted from the light source unit to pass through the opening member through an opening and block light other than the light entering the opening.

According to this structure, desired light coming from a light emission point passes through the opening, and light other than the desired light is blocked by the opening member. Thus, scan of light other than the desired light and generation of stray light reaching a screen can be reduced. Accordingly, high contrast and high quality images can be produced by the light source device at the time of scan of light from the light source device. Moreover, high contrast and high quality can be formed by the simple structure having the opening member.

It is preferable to further include a package which accommodates the light source unit, wherein the opening member is disposed within the package. By disposing the opening member inside the package, the size of the optical systems can be reduced. In addition, by disposing the opening member in the vicinity of the light source unit, light other than the desired light can be effectively blocked.

It is preferable that the opening member is disposed on a light emission end surface through which light is emitted on the light source unit. By disposing the opening member at the position closest to the light source unit, light other than the desired light can be most effectively blocked.

An image display apparatus according to a second aspect of the invention includes: the light source device described above which emits light according to an image signal; a collimating system which collimates light emitted from the light source device; and a scanning system which scans the light collimated by the collimating system. According to this structure, high contrast and high quality images can be produced by using the light source device described above. Accordingly, high contrast and high quality images can be displayed by the image display apparatus having this structure.

An image display apparatus according to a third aspect of the invention includes: a light source device which emits light according to an image signal; a collimating system which collimates the light emitted from the light source device; a scanning system which scans the light collimated by the collimating system; and an opening member disposed on the optical path of light emitted from the light source device to allow a part of the light emitted from the light source device to pass through the opening member through an opening and block light other than the light entering the opening. According to this structure, high contrast and high quality images can be displayed by the image display apparatus. Moreover, high contrast and high quality image can be formed by the simple structure having the opening member.

It is preferable that the opening member is disposed between the light source unit and the collimating system on the optical path. According to this structure, light other than the desired light can be blocked.

It is preferable that the opening member is disposed between the collimating system and the scanning system on the optical path. According to this structure, light other than the desired light can be blocked. By disposing the opening member at the position where the desired light is separated from light other than the desired light, the desired light from the light source unit can be accurately separated.

It is preferable that the scanning system includes a first scanning unit which scans the light collimated by the collimating system in a first scanning direction, and a second scanning unit which scans the light received from the first scanning unit in a second scanning direction. In this case, the light source device forms a light receiving area which is substantially orthogonal to the first scanning direction and is long in a particular direction, and the opening member is disposed in the vicinity of the first scanning unit. The vicinity of the first scanning unit refers to the area from a position on the first scanning unit to a position around the surface to which light from the collimating system enters on a transmitting unit to be described later, for example. By combining the light source device forming the light receiving area which is long in the particular direction and the first scanning unit scanning light in the first scanning direction, only the desired light is allowed to be used for scan. In the structure which disposes the opening member in the vicinity of the first scanning unit but away from the first scanning unit, light entering a position other than the opening on the opening member is blocked when light travels from the collimating system to the first scanning unit and when light travels from the first scanning unit to the second scanning unit. Accordingly, light other than the desired light can be effectively removed, and only the desired light is used for scan.

It is preferable that the opening is long in the first scanning direction with respect to the particular direction. According to this structure, desired light used for scan by the first scanning unit in the first scanning direction is allowed to pass through the opening, and light other than the desired light can be blocked by the portion other than the opening on the opening member.

It is preferable to further include: a transmitting unit which transmits light traveling from the collimating system to the first scanning unit and light traveling from the first scanning unit to the second scanning unit; and a scanning unit accommodating unit which accommodates the first scanning unit. In this case, the opening member is preferably disposed on the transmitting unit. By providing the opening member on the transmitting unit, an element necessary when the opening member is provided such as a structure for supporting the opening member is not required. Thus, the structure of the image display apparatus can be simplified.

It is preferable that the collimating system has a unit conjugate system which converges light emitted from the light source device, and an infinite conjugate system which collimates the light converged by the unit conjugate system. In this case, the opening member is preferably disposed between the unit conjugate system and the infinite conjugate system on the optical path. According to this structure, light other than the desired light can be blocked by the opening member. By disposing the opening member within the collimating system, the size of the optical systems can be reduced.

A light source device according to a fourth aspect of the invention includes: a light source unit; and a collimating system which collimates light emitted from the light source unit; wherein the light source unit has a first area for emitting light, and a second area and a third area having lower refractive index than that of the first area. The first area and the second area are adjacent to each other in a first direction substantially orthogonal to the light emission direction of the first area. The first area and the third area are adjacent to each other in a second direction substantially orthogonal to both the light emission direction of the first area and the first direction.

By disposing the first area and the second area adjacent to each other in the first direction and disposing the first area and the third area adjacent to each other in the second direction, carrier and light can be sufficiently closed in the first direction and the second direction. By sufficiently closing carrier and light in the first area, light leakage which may produce the belt-shaped light receiving area can be reduced, and only the desired light from the light emission point can be released. Accordingly, high contrast and high quality images can be produced by the light source device at the time of scan of light from the light source device.

An image display apparatus according to a fifth aspect of the invention includes: the light source device which emits light according to an image signal; a collimating system which collimates light emitted from the light source device; and a scanning system which scans the light collimated by the collimating system. By using the light source device described above, high contrast and high quality images can be produced. Accordingly, high contrast and high quality images can be displayed by the image display apparatus having this structure.

### BRIEF DESCRIPTION OF THE DRAWINGS

The invention will be described with reference to the accompanying drawings, wherein like numbers reference like elements.

FIG. 1 schematically illustrates a structure of an image display apparatus according to a first embodiment of the invention.

FIG. 2 is a perspective view schematically illustrating a laser chip.

FIG. 3 illustrates a structure of an opening member in the plan view.

FIG. 4 illustrates a light emission point of an active layer.

FIG. 5 illustrates behavior of light emitted from the laser chip.

FIG. 6 illustrates a beam spot.

FIG. 7 schematically illustrates an image display apparatus according to a second embodiment of the invention.

FIG. 8 illustrates a structure of an opening member in the plan view.

FIG. 9 schematically illustrates an image display apparatus according to a third embodiment of the invention.

FIG. 10 schematically illustrates an image display apparatus according to a fourth embodiment of the invention.

FIG. 11 is a perspective view illustrating a structure of a first scanning unit.

FIG. 12 illustrates a structure of components provided around the first scanning unit.

FIG. 13 is a cross-sectional view taken along a line A-A in FIG. 12.

FIG. 14 shows the relationship between the structure of an opening member and a beam receiving area.

FIG. 15 shows the relationship between the structure of the opening member and the first scanning unit.

FIG. 16 schematically illustrates an image display apparatus according to a fifth embodiment of the invention.

FIG. 17 schematically illustrates a cross-sectional structure of a laser chip shown in FIG. 16.

FIG. 18 schematically illustrates a cross-sectional structure of a laser chip according to a modified example of the fifth embodiment.

### DESCRIPTION OF EXEMPLARY EMBODIMENTS

Exemplary embodiments according to the invention are hereinafter described with reference to the drawings.

### First Embodiment

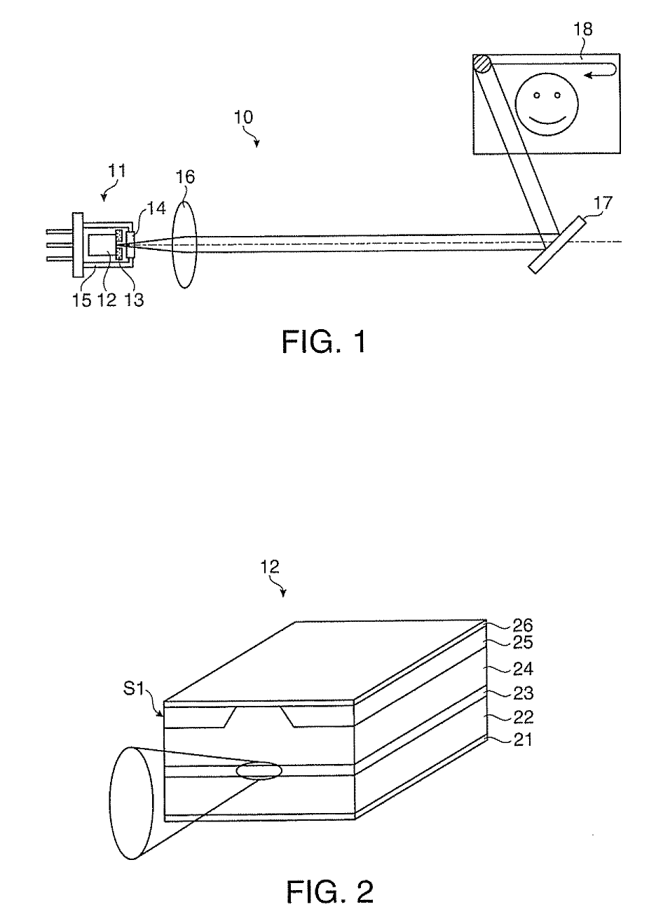

FIG. 1 schematically illustrates an image display apparatus 10 according to a first embodiment of the invention. The image display apparatus 10 displays an image by scan of laser beam modulated according to an image signal. A semiconductor laser 11 is a light source device which collimates light emitted from a light source unit by using a collimating system 16. A laser chip 12 is a light source unit for emitting laser beam modulated according to the image signal. Modulation according to the image signal may be performed by either amplification modulation or pulse width modulation. An opening member 13 is provided on the emission end surface of the laser chip 12 on the light emission side. The laser chip 12 and the opening member 13 are accommodated in a package 15 of the semiconductor laser 11. An emission unit 14 is disposed at the position to which the light having passed through the opening member 13 enters on the package 15. The emission unit 14 releases light coming from the laser chip 12 to the outside of the package 15. The emission unit 14 is constituted by transparent material.

The collimating system 16 is disposed at the position to which the light emitted from the semiconductor laser 11 enters. The collimating system 16 collimates the laser beam emitted from the laser chip 12. The front focus of the collimating system 16 substantially coincides with the light emission point of the laser chip 12. When the collimating system 16 is constituted by plural lenses, the positions of the respective lenses corresponding to the operation distances determined for each lens are disposed at the light emission point of the laser chip 12. A scanning system 17 scans a screen 18 using the light collimated by the collimating system 16. The image display apparatus 10 has light source devices for red (R) light, green (G) light, and blue (B) light, and a color combining system for combining the respective color lights. The details of the arrangement of the respective light source devices and the color combining system are not explained herein.

FIG. 2 is a perspective view schematically illustrating the structure of the laser chip 12. The laser chip 12 has a double hetero structure in which an active layer 23 is sandwiched between n-clad layer 22 and p-clad layer 24 having larger band gap and lower refractive index than those of the active layer 23. A trapezoidal ridge portion is formed on the side of the p-clad layer 24 opposite to the active layer 23. The ridge portion is disposed at the center in the direction parallel with the respective layers of the cross section shown in the figure. An n-light absorbing layer 25 is buried on both sides of the ridge portion. The laser chip 12 has the BR structure constituted by the ridge portion of the p-clad layer 24 and the n-light absorbing layer 25. A p-electrode 26 is formed on the ridge portion of the p-clad layer 24 and the n-light absorbing layer 25. An n-electrode 21 is disposed on the side of the n-clad layer 22 opposite to the active layer 23.

When current flows between the n-electrode 21 and the p-electrode 26, the active layer 23 oscillates laser beam. Since the active layer 23 is sandwiched between the n-clad layer 22 and the p-clad layer 24, carrier and light can be closed within the active layer 23 in the thickness direction of the respective layers with high density. Also, current concentrates on the ridge portion by providing the n-light absorbing layer 25 on both sides of the ridge portion of the p-clad layer 24. By concentrating current on the ridge portion, carrier and light can be concentrated on the portion where the ridge portion is disposed in the direction parallel with the respective layers. By this method, light can be efficiently released from one point on an emission end surface S1 of the laser chip 12.

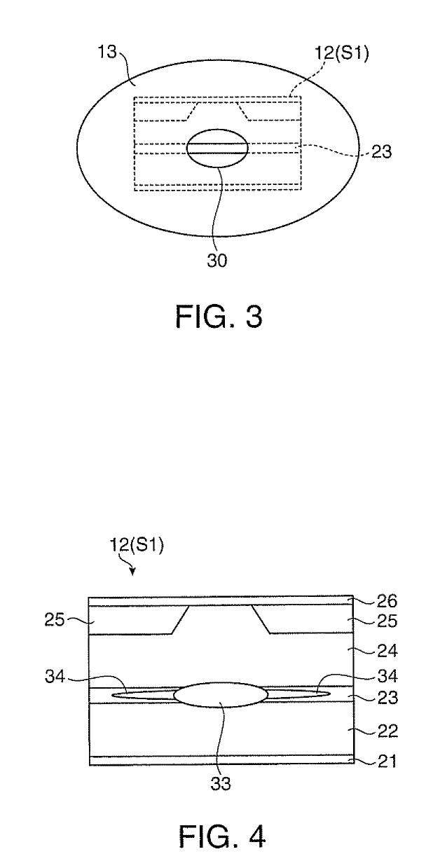

FIG. 3 illustrates a structure of the opening member 13 in the plan view. An opening 30 is disposed such that the center of the opening 30 agrees with the light emission position of the laser chip 12. The opening member 13 allows a part of light emitted from the laser chip 12 to pass through the opening 30, and blocks light other than the light entering the opening 30. For example, the opening 30 can be formed to match the area in which the intensity of light emitted from the laser chip 12 becomes l/e² of the peak intensity or higher. The shapes of the opening member 13 and the opening 30 are not limited to those shown in the figure, but may be appropriately changed. The shape of the opening 30 may be rectangular or circular, for example. The opening 30 is not required to be formed to match the area where the light intensity becomes 1/e² of the peak intensity or higher. It is possible, for example, that the opening 30 is narrower or wider than the area where the light intensity becomes 1/e² of the peak intensity or higher. The size of the opening 30 can be determined according to the light intensity distribution in the direction parallel with the active layer 23 as the light leak direction.

FIG. 4 illustrates light emission point of the active layer 23. According to this structure, carrier and light are not sufficiently closed in the direction parallel with the active layer 23 when compared with the thickness direction of the active layer 23, since carrier and light are concentrated in the direction parallel with the active layer 23 by concentration of current. Thus, light leaks in the direction parallel with the active layer 23, and a light emission area 34 which is long in the direction parallel with the active layer 23 is produced at a position adjacent to an original light emission point 33 in some cases.

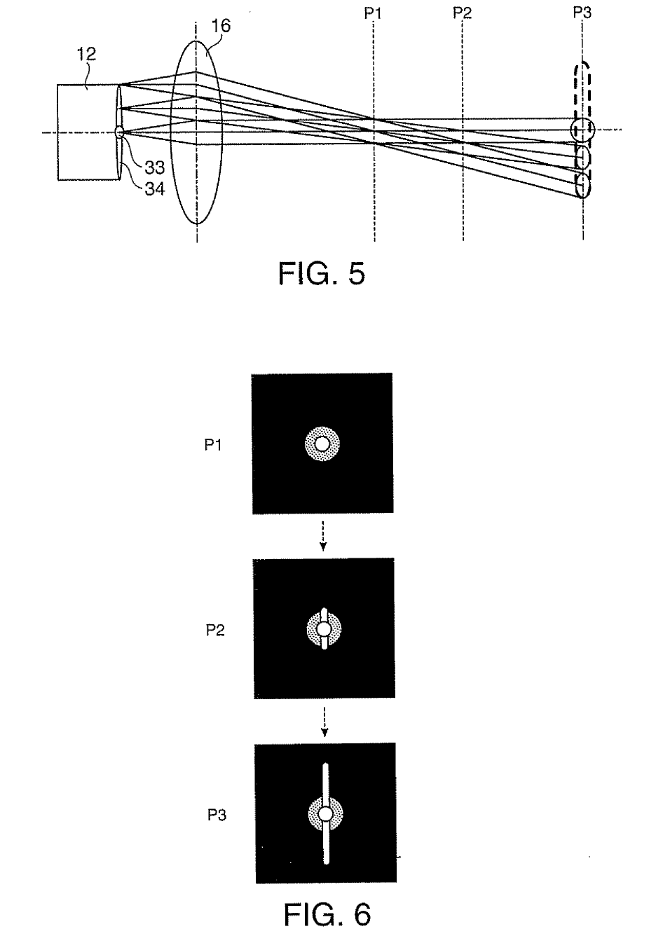

FIG. 5 illustrates behavior of light in the structure combining the laser chip 12 and the collimating system 16. While light coming from the original light emission point 33 is collimated by the collimating system 16, light coming from the light emission area 34 is bended by the collimating system 16 and travels in the diagonal direction. The light from the light emission area 34 is released from the collimating system 16, and then crosses the light from the light emission point 33 at a position P1. The light from the light emission area 34 goes away from the light coming from the light emission point 33 as the light from the light emission area 34 travels from the position P1 in the direction opposite to the collimating system 16.

FIG. 6 illustrates beam spots at respective positions P1, P2 and P3 in FIG. 5. At the position P1, the beam spot of light from the light emission point 33 overlaps with the beam spot of light from the light emission area 34. At each of the positions P2 and P3, a belt-shaped beam receiving area is produced by the light from the light emission area 34 as well as the circular beam spot produced by the light from the light emission point 33. The belt-shaped beam receiving area is long in the direction parallel with the active layer 23. The belt-shaped beam receiving area produced by the light from the light emission area 34 deforms to have a longer shape as the beam receiving area shifts from the position P1 toward the positions P2 and P3 in the direction away from the collimating system 16. Thus, the laser chip 12 forms the beam receiving area which is long in a particular direction. The belt-shaped beam receiving area is scanned together with the desired beam spot, or becomes stray light reaching the screen 18. In this case, the image contrast and image quality deteriorate.

According to the semiconductor laser 11 having the opening member 13, light from the light emission point 33 is allowed to pass through the opening 30, and light from the light emission area 34 is blocked by the opening member 13. Thus, desired light from the light emission point 33 is released through the opening 30, and other light is blocked by the opening member 13. Accordingly, scan of light other than the desired light and generation of stray light reaching the screen 18 can be reduced, and therefore images having high contrast and high quality can be formed at the time of scan of light from the semiconductor laser 11. Moreover, high contrast and high quality images can be produced by a simple structure having the opening member 13.

Light from the light emission area 34 has low directivity and is released in any directions. Thus, the light from the light emission area 34 can be more effectively blocked as the position of the light is located closer to the emission end surface S3 of the laser chip 12. By disposing the opening member 13 on the emission end surface S1 of the laser chip 12, the light from the light emission area 34 can be most effectively blocked. The opening member 13 may be provided at a position other than on the emission end surface S1 of the laser chip 12. The opening member 13 may be disposed at the emission unit 14 as a position other than on the emission end surface X1 of the laser chip 12 inside the package 15, for example. When the opening member 13 is disposed adjacent to the emission end surface S3, the opening member 13 is preferably made of insulation material for preventing change of the electronic structure in the laser chip 12.

By disposing the opening member 13 inside the package 15, the size of the optical systems can be reduced. Moreover, by disposing the opening member 13 at a position close to the laser chip 12, light from the light emission area 34 can be effectively blocked. The position of the opening member 13 is not limited to a position inside the package 15, but may be any position at least on the optical path between the semiconductor laser 11 and the collimating system 16. The shape and size of the laser beam emitted from the light emission point 33 vary according to the distance between the laser chip 12 and the opening member 13. It is preferable that the opening 30 is formed according to the shape and size of laser beam at the position of the opening member 13.

### Second Embodiment

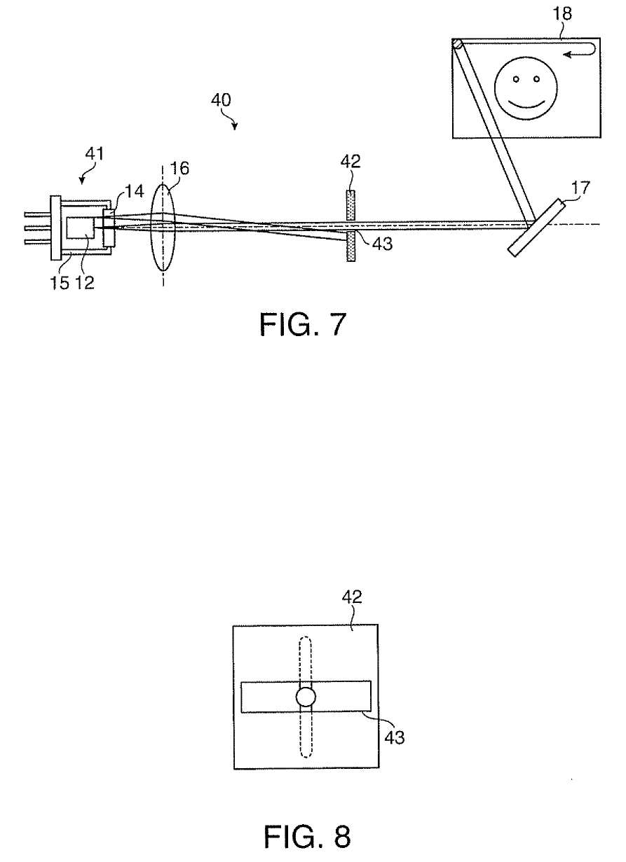

FIG. 7 schematically illustrates a structure of an image display apparatus 40 according to a second embodiment of the invention. The image display apparatus 40 in this embodiment is characterized by including an opening member 42 provided between the collimating system 16 and the scanning system 17. Similar reference numbers are given to parts similar to those in the first embodiment, and the same explanation is not repeated. A semiconductor laser 41 is a component formed by removing the opening member 13 from the semiconductor laser 11 of the first embodiment (see FIG. 1). The semiconductor laser 41 produces a beam receiving area which is long in a particular direction. The opening member 42 is disposed at a position where the desired light from the light emission point 33 separates from the light from the light emission area 34 as the position P3 shown in FIG. 6.

FIG. 8 illustrates the structure of the opening member 42 in the plan view. The opening member 42 has a slit-shaped opening 43. The opening 43 is formed such that its longitudinal direction corresponds to the direction orthogonal to the belt-shaped beam receiving area. The light from the light emission point 33 (see FIG. 6) enters the opening 43. The light from the light emission area 34 enters a position other than the opening 43 on the opening member 42. It is preferable that the slit width of the opening 43 is slightly larger than the spot diameter of the desired light from the light emission point 33. In this case, the light from the light emission point 33 can pass through the opening 43 without loss.

By this method, the light from the light emission point 33 is allowed to pass through the opening 43, and the light from the light emission area 34 is blocked by the opening member 42. As a result, high contrast and high quality images can be produced. By disposing the opening member 42 at the position where the desired light from the light emission point 33 separates from the light from the light emission area 34, the desired light can be accurately divided from the light from the laser chip 12. The opening member 42 may be located at any position on the optical path between the collimating system 16 and the scanning system 17 as long as the position corresponds to a location where the light from the light emission point 33 separates from the light from the light emission area 34.

The opening member 42 may be disposed on the scanning system 17. Since the opening member 42 may be located at any position as long as the position corresponds to a location where the light from the light emission point 33 separates from the light from the light emission area 34, the respective components can be easily positioned. The scanning system may scan light by using a mirror having a size equivalent to that of the spot of the desired light from the light emission point 33. An effect similar to blocking by the opening member 42 can be provided by shifting the light coming from the light emission area 34 from the mirror.

According to this embodiment, an opening member having an opening elliptic or shaped otherwise may be used similarly to the first embodiment. Also, an opening member having a slit-shaped opening may be used in the first embodiment. When the opening member is provided on the emission end surface S1 of the semiconductor laser, the slit width of the opening is determined according to the width of the ridge portion of the p-clad layer 24 (see FIG. 2), for example.

### Third Embodiment

FIG. 9 schematically illustrates a structure of an image display apparatus 50 according to a third embodiment of the invention. The image display apparatus 50 in this embodiment is characterized by including an opening member 55 provided within a collimating system 53. Similar reference numbers are given to parts similar to those in the embodiment described above, and the same explanation is not repeated. A unit conjugate system 51 converges light emitted from the semiconductor laser 41. An infinite conjugate system 52 collimates the light converged by the unit conjugate system 51. The unit conjugate system 51 and the infinite conjugate system 52 constitute the collimating system 53. The opening member 55 is disposed between the unit conjugate system 51 and the infinite conjugate system 52 on the optical path.

The rear focus of the unit conjugate system 51 agrees with the front focus of the infinite conjugate system 52. The opening member 55 is disposed in the vicinity of the agreement position between the rear focus of the unit conjugate system 51 and the front focus of the infinite conjugate system 52. The opening member 55 has a pin hole 56 as an opening. Light from the light emission point 33 (see FIG. 6) converges at the pin hole 56. Light from the light emission area 34 enters a position other than the pin hole 56 on the opening member 55. The pin hole 56 is the most effective when disposed at such a position that the rear focus of the unit conjugate system 51 coincides with the front focus of the infinite conjugate system 52. However, sufficient effect can be obtained when the pin hole 56 is located in the vicinity of this position.

Thus, light from the light emission point 33 is allowed to pass through the pin hole 56, and light from the light emission area 34 is blocked by the opening member 55. In this structure, high contrast and high quality images can be produced. By disposing the opening member 55 within the collimating system 53, the size of the optical systems can be reduced. In this embodiment, an opening member having a slit-shaped opening may be used similarly to the second embodiment.

### Fourth Embodiment

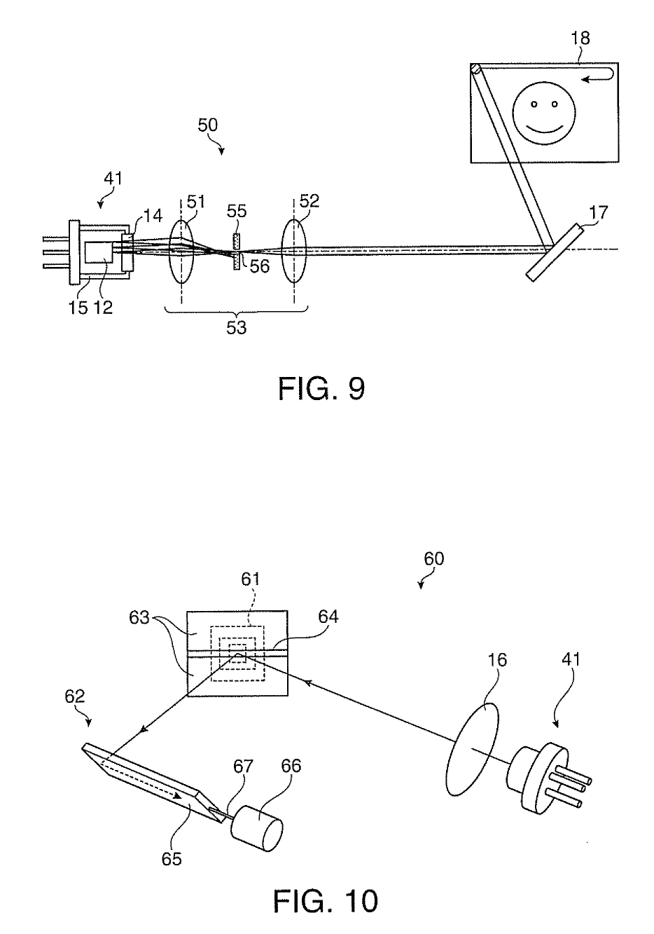

FIG. 10 schematically illustrates an image display apparatus 60 according to a fourth embodiment of the invention. The image display apparatus 60 has a first scanning unit 61 and a second scanning unit 62. The first scanning unit 61 and the second scanning unit 62 function as a scanning system for scanning light collimated by the collimating system 16. The first scanning unit 61 scans light in a first scanning direction. The first scanning direction corresponds to the horizontal direction, for example. The second scanning unit 62 scans light in a second scanning direction. The second scanning direction is the vertical direction, for example. The first scanning unit 61 and the second scanning unit 62 scan a not-shown screen by beams in the two-dimensional direction. The image display apparatus 60 in this embodiment is characterized by including an opening member 63 disposed in the vicinity of the first scanning unit 61. Similar reference numbers are given to parts similar to those in the embodiments discussed above, and the same explanation is not repeated. In FIG. 10, the first scanning unit 61 is disposed on the inner side from the opening member 63 with respect to the sheet surface of the figure. The opening member 63 has a slit-shaped opening 64.

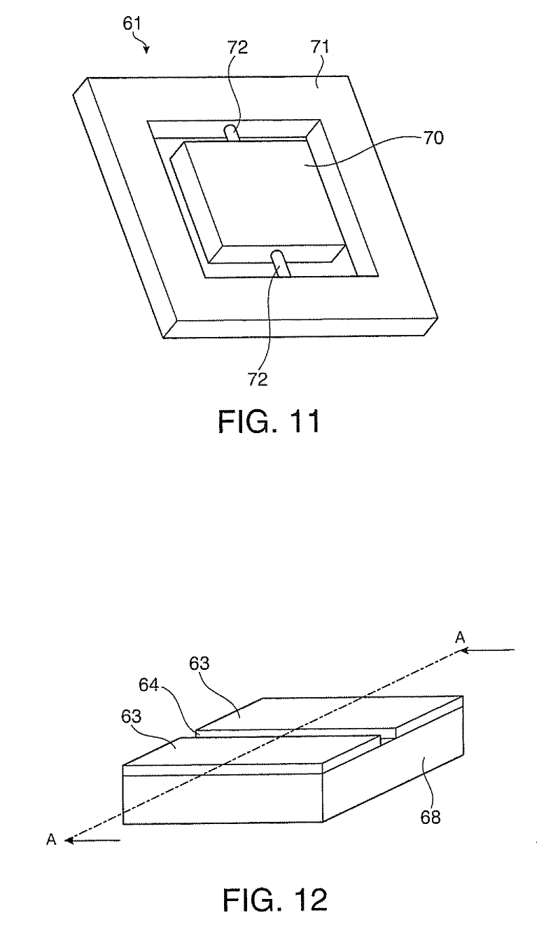

FIG. 11 is a perspective view illustrating the structure of the first scanning unit 61. The first scanning unit 61 has a movable mirror 70 for reflecting light. The movable mirror 70 is formed by coating a rectangular plate-shaped member with a dielectric multi-layer film or a metal film which is a high-reflective members. A mirror supporting member 71 is provided around the movable mirror 70. The mirror supporting member 71 supports the movable mirror 70. The movable mirror 70 is connected with the mirror supporting member 71 via torsion springs 72. The movable mirror 70 rotates around the torsion springs 72 as a rotation axis by external force given from a drive unit (not shown) and returning force of the torsion springs 72 twisted by the external force. By rotating the movable mirror 70 around the torsion springs 72, the first scanning unit 61 scans light in the first direction as the direction substantially orthogonal to the torsion springs 72.

The drive unit drives the movable mirror 70 by electrostatic force, for example. The movable mirror 70, the drive unit, the mirror supporting member 71, and the torsion springs 72 are manufactured by MEMS technology, for example. The figure and detailed explanation of the drive unit for driving the movable mirror 70 are not shown herein. The drive unit is not limited to the type which uses electrostatic force to drive the movable mirror 70, but may be such a type which uses electromagnetic force or expansion and contraction force of piezoelectric element.

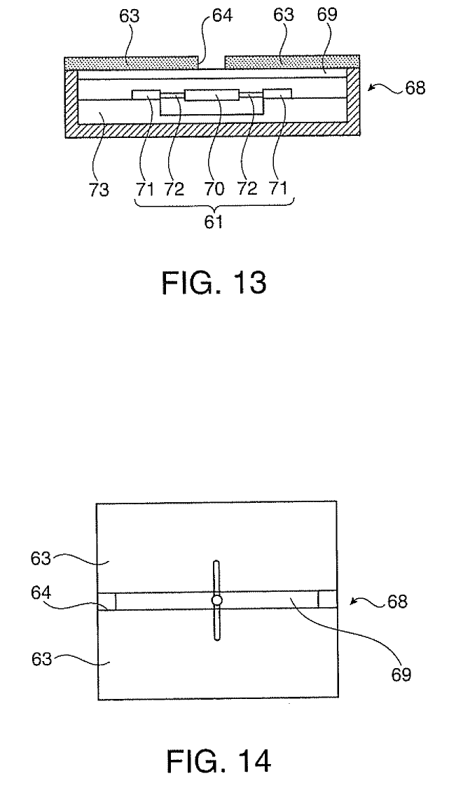

FIG. 12 illustrates the structure of the components provided around the first scanning unit 61. FIG. 13 is a cross-sectional view taken along a line A-A in FIG. 12. A scanning unit cover 68 functions as a scanning unit accommodating unit for accommodating the first scanning unit 61. The mirror supporting member 71 is disposed on a base 73 provided inside the scanning unit cover 68. The base 73 is disposed on the bottom of the scanning unit cover 68 on the side opposite to the side where a transmitting unit 69 is provided. The inside of the scanning unit cover 68 is sealed under the pressure-reduced condition. By reduction of the pressure inside the scanning unit cover 68, the air resistance to the movable mirror 70 can be decreased. Moreover, by sealing the inside of the scanning unit cover 68, adhesion of foreign material to the movable mirror 70 or the like can be reduced. According to this structure, the first scanning unit 61 can scan light at a high speed and a large scanning angle, and secures high reliability.

The transmitting unit 69 is provided on the surface of the scanning unit cover 68 to which light from the collimating system 16 enters. The transmitting unit 69 transmits light entering the first scanning unit 61 from the collimating system 16, and light traveling from the first scanning unit 61 toward the second scanning unit 62. The transmitting unit 69 is a plate-shaped member constituted by transparent material such as glass and transparent resin. The opening member 63 is provided on the surface of the transmitting unit 69 to which light from the collimating system 16 enters. The opening member 63 is formed by applying light absorbing material to the transmitting unit 69, for example. By providing the opening member 63 on the transmitting unit 69, the scanning unit cover 68 provides function of blocking light other than the desired light as well as function of accommodating the first scanning unit 61. Not-shown anti-reflection film (AR coat) is provided at the portion of the transmitting unit 69 where the opening 64 is disposed. By reducing reflection of light passing through the opening 64, light from the collimating system 16 can be efficiently supplied to the first scanning unit 61, and light from the first scanning unit 61 can be efficiently supplied to the second scanning unit 62.

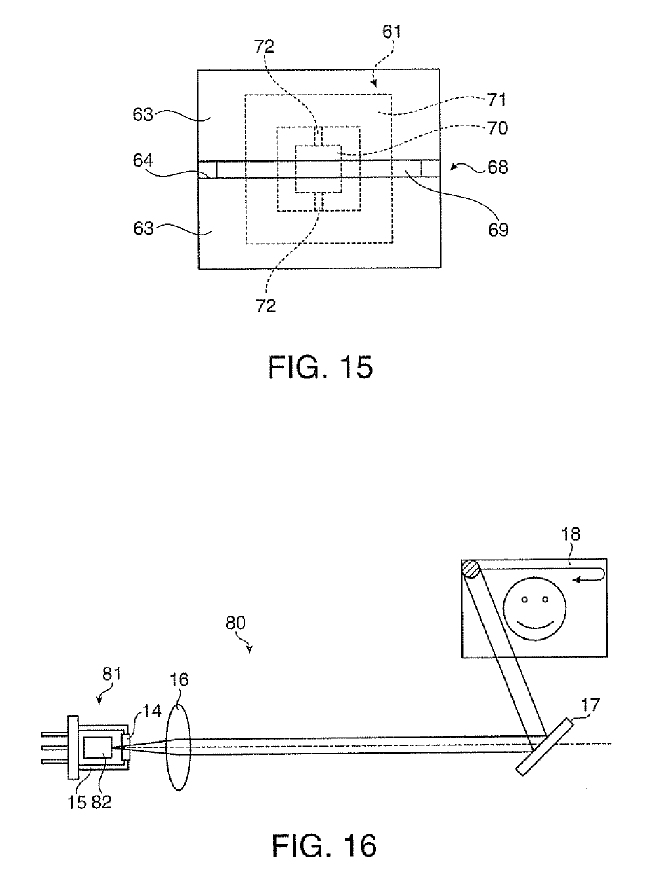

FIG. 14 shows the relationship between the structure of the opening member 63 and the beam receiving area for receiving light from the semiconductor laser 41. FIG. 15 shows the relationship between the structure of the opening member 63 and the structure of the first scanning unit 61. As apparent from FIG. 6, the beam receiving area for receiving light emitted from the semiconductor laser 41 becomes a belt-shaped area which becomes longer in a particular direction as the position of the beam receiving area shifts away from the collimating system 16 in the direction opposite to the semiconductor laser 41. The semiconductor laser 41 produces the belt-shaped beam receiving area at the position of the opening member 63. According to the structure shown in the plan view, the particular direction as the longitudinal direction of the beam receiving area corresponds to the up-down direction parallel with the sheet surface.

The longitudinal direction of the beam receiving area is substantially parallel with the torsion springs 72 on the opening member 63. In the structure shown in the plan view, the first scanning direction corresponds to the left-right direction parallel with the sheet surface. Thus, the semiconductor laser 41 and the first scanning unit 61 are positioned such that the longitudinal direction of the beam receiving area is disposed substantially orthogonal to the first scanning direction. The opening 64 is formed along the first scanning direction. The opening 64 has a slit shape which is long in the first scanning direction relative to the longitudinal direction of the beam receiving area. The slit width of the opening 64 is substantially equivalent to the spot diameter of the desired light from the light emission point 33 (see FIG. 5), or slightly larger than the spot diameter.

Returning to FIG. 10, the second scanning unit 62 has a movable mirror 65 for reflecting light. The movable mirror 65 is connected with a galvano-meter 66 via a rotation shaft 67. The movable mirror 65 rotates around the rotation shaft 67 by the drive of the galvano-meter 66. By rotating the movable mirror 65 around the rotation shaft 67, the second scanning unit 62 scans light in a second direction substantially orthogonal to the rotation shaft 67. Since the movable mirror 65 of the second scanning unit 62 reflects light used for the scan by the first scanning unit 61, the size of the movable mirror 65 is larger than the movable mirror 70 of the first scanning unit 61. The second scanning unit 62 scans light at a frequency lower than the frequency for the light scan by the first scanning unit 61. The second scanning unit 62 may have a structure similar to that of the first scanning unit 61.

Light emitted from the semiconductor laser 41 is collimated by the collimating system 16, and enters the opening member 63. Light from the light emission point 33 enters the opening 64. Light from the light emission area 34 enters a position other than the opening 64 on the opening member 63. The light having passed the opening 64 passes the transmitting unit 69, and then enters the movable mirror 70 of the first scanning unit 61. The light reflected by the movable mirror 70 passes through the transmitting unit 69, and then enters the opening member 63. The light having passed the opening 64 from the first scanning unit 61 side travels toward the second scanning unit 62. The light from the second scanning unit 62 enters a not-shown screen. The image display apparatus 60 scans light in the two-dimensional direction by using the first scanning unit 61 and the second scanning unit 62.

By combining the semiconductor laser 41 forming the beam receiving area which is long in the particular direction and the first scanning unit 61 scanning light in the first scanning direction, scanning can be performed by using only the desired light emitted from the light emission point 33. By disposing the opening member 63 on the transmitting unit 69 in the vicinity but away from the first scanning unit 61, light entering a position other than the opening 64 on the opening member 63 can be blocked when light travels from the collimating system 16 to the first canning unit 61 and when light travels from the first scanning unit 61 to the second scanning unit 62. By providing the opening 64 which is long in the first scanning direction with respect to the longitudinal direction of the beam receiving area, the first scanning unit 61 allows the desired light used for scan in the first scanning direction to pass through the opening 64 and blocks light other than the desired light by the portion other than the opening 64 on the opening member 63. In this structure, light other than the desired light can be effectively removed by the simple structure, and only the desired light can be used for scanning. Similarly to the above embodiments, high contrast and high quality images can be produced according to this embodiment.

The opening member 63 is not required to be disposed on the surface to which light from the collimating system 16 enters on the transmitting unit 69, but may be disposed at least in the vicinity of the first scanning unit 61. For example, the opening member 63 may be located on the first scanning unit 61 side surface of the transmitting unit 69, or on the movable mirror 70 of the first scanning unit 61. The vicinity of the first scanning unit 61 refers to the area from a position on the first scanning unit 61 to a position around the surface to which light from the collimating system 16 enters on the transmitting unit 69, for example. Light other than the desired light can be more effectively removed as the distance between the position of the opening member 63 and the first scanning unit 61 becomes longer when light travels from the collimating system 16 to the first scanning unit 61 and when light travels from the first scanning unit 61 to the second scanning unit 62.

### Fifth Embodiment

FIG. 16 schematically illustrates an image display apparatus 80 according to a fifth embodiment of the invention. The image display apparatus 80 in this embodiment is characterized by including a semiconductor laser 81 having a buried hetero (BH) structure laser chip 82. Similar reference numbers are given to parts similar to those in the embodiments discussed above, and the same explanation is not repeated.

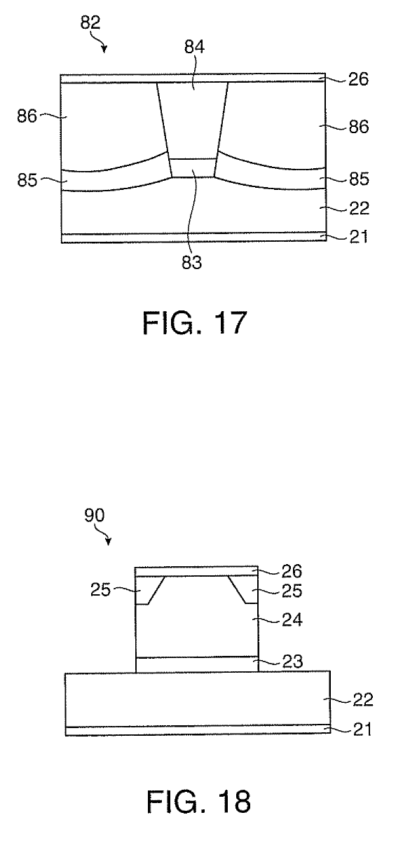

FIG. 17 schematically illustrates a cross-sectional structure of the laser chip 82. An active layer 83 and a p-clad layer 84 are disposed at the central portion of the cross section shown in the figure in the direction parallel to the respective layers. The active layer 83 constitutes a first area for emitting light. The p-clad layer 84 is accumulated on the active layer 83. The p-clad layer 84 constitutes a second area having lower refractive index than that of the first area. The active layer 83 and the p-clad layer 84 are adjacent to each other in a first direction as the thickness direction of the respective layer. The first direction is substantially orthogonal to the light emission direction of the active layer 83.

A p-buried layer 85 and an n-buried layer 86 having lower refractive index than that of the active layer 83 are buried on both sides of the active layer 83 and the p-clad layer 84. The p-buried layer 85 is accumulated on the n-clad layer 22. The p-buried layer 85 constitutes a third area having lower refractive index than that of the active layer 83 as the first area. The active layer 83 and the p-buried layer 85 are adjacent to each other in a second direction as a direction parallel with the respective layers. The second direction is substantially orthogonal both to the light emission direction of the active layer 83 and the first direction. The n-buried layer 86 is accumulated on the p-buried layer 85. The p-electrode 26 is provided on the p-clad layer 84 and the n-buried layer 86.

By the functions of the active layer 83 and the p-clad layer 84 having a structure similar to the ordinary double hetero structure, carrier and light can be closed in the active layer 83 with high density in the first direction. Also, by the function of the p-buried layer 85 formed on both sides of the active layer 83, carrier and light can be closed in the active layer 83 with high density in the second direction. By this structure, light can be efficiently emitted from the light emission point of the laser chip 82.

By sufficiently closing carrier and light in the active layer 83, leakage of light which produces the belt-shaped beam receiving area can be reduced, and only the desired light emitted from the light emission point can be released. Thus, high contrast and high quality images can be produced at the time of scan of light from the semiconductor laser 81.

FIG. 18 schematically illustrates the cross-sectional structure of a laser chip 90 in a modified example of this embodiment. The laser chip 90 in this modified example is formed by removing the portion of the active layer 23 other than the ridge portion, the p-clad layer 24, the n-light absorbing layer 25, and p-electrode 26 from the laser chip 12 in the first embodiment (see FIG. 2). The active layer 23 as the first area and the p-clad layer 24 as the second area are adjacent to each other in the first direction.

The part from which the p-clad layer 24, the n-light absorbing layer 25, and the p-electrode 26 are removed corresponds to the third area having lower refractive index than that of the active layer 23. The portion corresponding to the third area and the active layer 23 are adjacent to each other in the second direction. In this modified example, carrier and light can be sufficiently closed in the active layer 23 similarly to the above embodiments, and light leakage can be reduced. The laser chip in this example is only required to be constructed such that an area having lower refractive index than that of the active layer is disposed adjacent to the active layer in the first and second directions, and modifications may be made in an appropriate manner. The respective structures in the above embodiments are applicable to electronic device for laser beam scanning such as laser printer as well as the image display device.

Accordingly, the light source device and the image display apparatus according to the embodiments of the invention are appropriately used when images are displayed by using laser beams.

The entire disclosure of Japanese Patent Application Nos. 2007-292875, filed Nov. 12, 2007 and 2008-043934, filed Feb. 26, 2008 are expressly incorporated by reference herein.

What is claimed is:

1. A light source device whose emitted light is collimated using a collimating system, the device comprising:
a light source unit; and
an opening member disposed on the optical path of light emitted from the light source unit to allow a part of the light emitted from the light source unit to pass through the opening member through an opening and block light other than the light entering the opening.

2. The light source device according to claim 1, further comprising a package which accommodates the light source unit, wherein the opening member is disposed within the package.

3. The light source device according to claim 1, wherein the opening member is disposed on a light emission end surface through which light is emitted on the light source unit.

4. An image display apparatus comprising:
a light source device which includes
a light source unit, and
an opening member disposed on the optical path of light emitted from the light source unit to allow a part of the light emitted from the light source unit to pass through the opening member through an opening and block light other than the light entering the opening;
a collimating system which collimates light emitted from the light source device; and
a scanning system which scans the light collimated by the collimating system.

5. The image display apparatus according to claim 4, further comprising a package which accommodates the light source unit, wherein the opening member is disposed within the package.

6. The image display apparatus according to claim 4, wherein the opening member is disposed on a light emission end surface through which light is emitted on the light source unit.

7. An image display apparatus comprising:
a light source device which has a light source unit and emits light from the light source unit according to an image signal;
a collimating system which collimates the light emitted from the light source device;
a scanning system which scans the light collimated by the collimating system; and
an opening member disposed on the optical path of light emitted from the light source device to allow a part of the light emitted from the light source device to pass through the opening member through an opening and block light other than the light entering the opening.

8. The image display apparatus according to claim 7, wherein the opening member is disposed between the light source device and the collimating system on the optical path.

9. The image display apparatus according to claim 7, wherein the opening member is disposed between the collimating system and the scanning system on the optical path.

10. The image display apparatus according to claim 7, wherein:
the scanning system includes a first scanning unit which scans the light collimated by the collimating system in a first scanning direction, and a second scanning unit which scans the light received from the first scanning unit in a second scanning direction;
the light source device forms a light receiving area which is substantially orthogonal to the first scanning direction and is long in a particular direction; and
the opening member is disposed in the vicinity of the first scanning unit.

11. The image display apparatus according to claim 10, wherein the opening is long in the first scanning direction with respect to the particular direction.

12. The image display apparatus according to claim 10, further comprising:
a transmitting unit which transmits light traveling from the collimating system to the first scanning unit and light traveling from the first scanning unit to the second scanning unit; and
a scanning unit accommodating unit which accommodates the first scanning unit,
wherein the opening member is disposed on the transmitting unit.

13. The image display apparatus according to claim 7, wherein:
the collimating system has a unit conjugate system which converges light emitted from the light source device, and an infinite conjugate system which collimates the light converged by the unit conjugate system; and
the opening member is disposed between the unit conjugate system and the infinite conjugate system on the optical path.

14. The image display apparatus according to claim 13, wherein the opening member is disposed in the vicinity of the position where the rear focus of the unit conjugate system coincides with the front focus of the infinite conjugate system.

15. The image display apparatus according to claim 14, wherein:
the opening member has a pin hole as the opening; and
the pin hole is disposed in the vicinity of the position where the rear focus of the unit conjugate system coincides with the front focus of the infinite conjugate system.

16. The light source device according to claim 1, wherein the light emission area of the light source unit is sandwiched between regions having lower refractive index than that of the light emission area in a first direction substantially orthogonal to the light emission direction of the light emission area.

17. The image display apparatus according to claim 4, wherein the light emission area of the light source unit is sandwiched between regions having lower refractive index than that of the light emission area in a first direction substantially orthogonal to the light emission direction of the light emission area.

18. The image display apparatus according to claim 7, wherein the light emission area of the light source unit is sandwiched between regions having lower refractive index than that of the light emission area in a first direction substantially orthogonal to the light emission direction of the light emission area.

19. A light source device whose emitted light is collimated using a collimating system, the device comprising:
a light source unit which has a first area for emitting light, and a second area and a third area having lower refractive index than that of the first area,
wherein
the first area and the second area are adjacent to each other in a first direction substantially orthogonal to the light emission direction of the first area, and
the first area and the third area are adjacent to each other in a second direction substantially orthogonal to both the light emission direction of the first area and the first direction.

20. The light source device according to claim 18, further comprising:
a fourth area having lower refractive index than that of the first area,
wherein the first area and the fourth area are disposed adjacent to each other in the first direction substantially orthogonal to the light emission direction of the first area on the side opposite to the second area.

21. The light source device according to claim 18, wherein the third area is a semiconductor layer.

22. An image display apparatus comprising:
a light source device which includes a light source unit having a first area for emitting light, and a second and a third area having lower refractive index than that of the first area, the first area and the second area being adjacent to each other in a first direction substantially orthogonal to the light emission direction in the first area, and the first area and the third area being adjacent to each other in a second direction substantially orthogonal to both the light emission direction of the first area and the first direction;
a collimating system which collimates light emitted from the light source device; and
a scanning system which scans the light collimated by the collimating system.

23. The image display apparatus according to claim 22, further comprising:
a fourth area having lower refractive index than that of the first area,
wherein the first area and the fourth area are disposed adjacent to each other in the first direction substantially orthogonal to the light emission direction of the first area on the side opposite to the second area.

24. The image display apparatus according to claim 22, wherein the third area is a semiconductor layer.
